(19) United States
(12) Patent Application Publication
(10) Pub. No.: US 2015/0324498 A1
(43) Pub. Date: Nov. 12, 2015

(54) ELECTROMAGNETIC FIELD SIMULATION METHOD AND ELECTROMAGNETIC FIELD SIMULATION SYSTEM

(71) Applicant: FUJITSU LIMITED, Kawasaki-shi (JP)

(72) Inventors: Hirotomo IZUMI, Kawasaki (JP); Kenji Nagase, Yokohama (JP)

(73) Assignee: Fujitsu Limited, Kawasaki-shi (JP)

(21) Appl. No.: 14/620,662

(22) Filed: Feb. 12, 2015

(30) Foreign Application Priority Data
May 8, 2014 (JP) 2014-097092

(51) Int. Cl. G06F 17/50; G06F 17/10

(52) U.S. Cl. CPC G06F 17/5009; G06F 17/10

(57) ABSTRACT

An electromagnetic field simulation method includes: obtaining, when a reference signal including a plurality of frequencies is input to a first point of design data of an object, a variation of a reference signal at a second point by a computer through an electromagnetic field simulation; calculating variable data at each of the plurality of frequencies based on the variation of the reference signal; frequency-decomposing a signal applied to the first point; and calculating a frequency distribution of the signal at the second point which propagates from the first point based on the frequency-decomposed signal and the variable data at each of the plurality of frequencies.

### CROSS-REFERENCE TO RELATED APPLICATIONS

This application is based upon and claims the benefit of priority from the prior Japanese Patent Application No. 2014-097092 filed on May 8, 2014, the entire contents of which are incorporated herein by reference.

### FIELD

The embodiments discussed herein are related to an electromagnetic field simulation method and an electromagnetic field simulation system.

### BACKGROUND

Radio waves or noises generated by electronic devices may cause a harmful interference in operations of other electronic devices. Accordingly, in accordance with the standards defined by, for example, the VCCI in Japan and the FCC in the U.S., there is a restriction that an electronic device must not radiate radio waves or noises exceeding a predetermined level.

Related technologies are disclosed in Japanese Laid-Open Patent Publication No. 2001-356142.

### SUMMARY

According to one aspect of the embodiments, an electromagnetic field simulation method includes: obtaining, when a reference signal including a plurality of frequencies is input to a first point of design data of an object, a variation of a reference signal at a second point by a computer through an electromagnetic field simulation; calculating variable data at each of the plurality of frequencies based on the variation of the reference signal; frequency-decomposing a signal applied to the first point; and calculating a frequency distribution of the signal at the second point which propagates from the first point based on the frequency-decomposed signal and the variable data at each of the plurality of frequencies.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates an example of an electric field intensity predicting apparatus;

FIG. 2 illustrates an example of a system;

FIGS. 3A and 3B illustrate an example of a reference wave;

FIG. 4 illustrates an example of a record layout of a reference table;

FIG. 5 illustrates an example of a record layout of a test table;

FIG. 6 illustrates an example of a record layout of an electric field intensity table;

FIG. 7 illustrates an example of an electric field intensity prediction processing;

FIG. 8 illustrates an example of an electric field intensity; and

FIG. 9 illustrates an example of an electric field intensity predicting apparatus.

### DESCRIPTION OF EMBODIMENTS

When an electronic device is designed, various measures are incorporated into the design in order to satisfy the specification, and at the same time, the validity of the incorporated measures is verified. In the verification, since radio waves or noises radiated from an experimentally produced electronic device are measured, a time and a cost are consumed. Accordingly, the effects of the measures are quantitatively verified on a desk using an electromagnetic field simulation.

As one of simulation methods, a finite-difference time-domain (FDTD) method (a differential time domain method) may be used.

When radio waves or noises radiated from an electronic device are measured using an electromagnetic field simulation, a calculation time is increased according to an increase of a calculation amount. For example, a situation where a noise is generated at any one point (which will be referred to as a “first point”) of an electronic device and then propagated to an observation point (which will be referred to as a “second point”), is evaluated by a simulation. In a period of time during which the noise is generated at the first point and a steady state is recovered after the noise stops, the situation of the second point is evaluated. When the steady state is recovered, the noise already stopped at the first point, and passed the second point to propagate to a farther side. As a result, the noise is no longer observed at the second point. Therefore, even when the noise generated at the first point is a noise generated in a short time, such as an impulse noise, a simulation for a recovery time to the steady state is performed. For example, when an FDTD method is used as for a simulation method, a longer evaluation time indicates that steps in the time axis direction increase because the FDTD method is an analysis in the time domain. This may increase the calculation amount.

When the FDTD method is used for an analysis in a frequency domain, an analysis result in the time domain is converted into a frequency domain result. A calculation in the time axis direction is performed a certain number of times or more to accurately perform the analysis in the frequency domain. Thus, the calculation amount in the time domain may be increased. In order to increase the accuracy of the Fourier transform used for converting the analysis result in the time domain into the frequency domain result, the time of a simulation target may become longer. In an electromagnetic field simulation using the FDTD method, a computer occupation time may become longer so that the analysis may not be ended within a practical time.

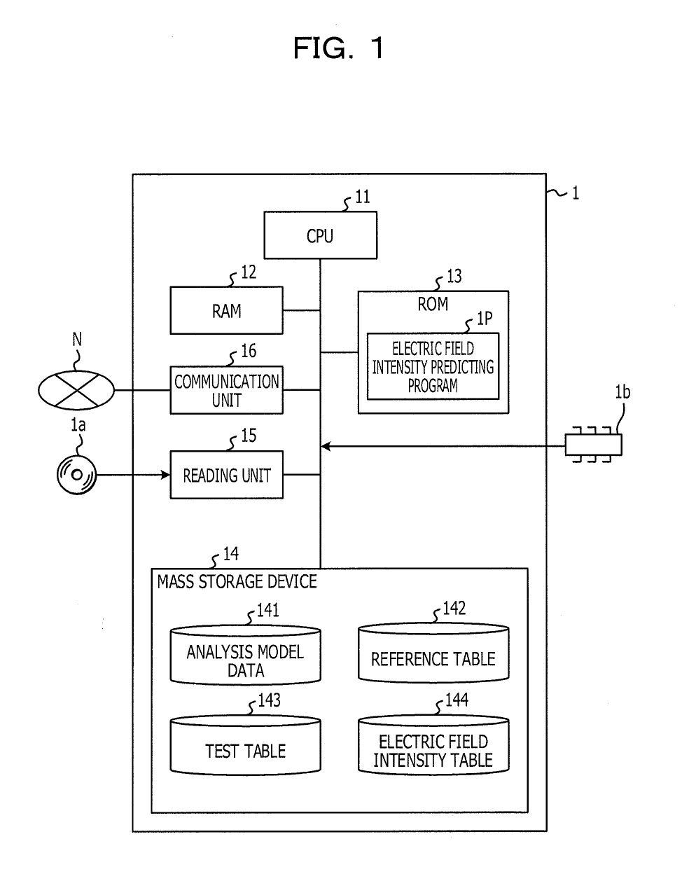

FIG. 1 illustrates an example of an electric field intensity predicting apparatus. FIG. 1 illustrates a hardware configuration of an electric field intensity predicting apparatus 1. The electric field intensity predicting apparatus 1 includes a central processing unit (CPU) 11, a random access memory (RAM) 12, a read only memory (ROM) 13, a mass storage device 14, a reading unit 15 and a communication unit 16. The respective configuration units are coupled by a bus.

The CPU 11 controls the respective units of the hardware according to an electric field intensity predicting program (an electromagnetic field simulation program) 1P stored at the ROM 13. The RAM 12 may be, for example, a static RAM (SRAM), a dynamic RAM (DRAM) or a flash memory. The RAM 12 temporarily stores data generated when the program is executed by the CPU 11.

The mass storage device 14 may be, for example, a hard disk or a solid state drive (SSD). The mass storage device 14 stores analysis model data 141, a reference table 142, a test table 143 and an electric field intensity table 144. The electric field intensity predicting program 1P may be stored in the mass storage device 14.

The reading unit 15 reads out a portable recording medium is such as a compact disk (CD)-ROM or a digital versatile disc (DVD)-ROM. The communication unit 16 communicates with other computers via a network N. The electric field intensity predicting program 1P may be read out by the CPU 11 through the reading unit 15 from the portable recording medium 1a, and then stored in the mass storage device 14. The CPU 11 may download the electric field intensity predicting program 1P from another computer via the network N, and then store the electric field intensity predicting program 1P in the mass storage device 14. The CPU 11 may read out the electric field intensity predicting program 1P from a semiconductor memory 1b.

The electric field intensity predicting apparatus 1 may be a dedicated device, or a general-purpose computer such as a personal computer or a server computer.

In the FDTD method, in a virtual space (analysis space) in which a shape of a physical object is defined, points for calculation of an electric field intensity (electric field calculation points) and points for calculation of a magnetic field intensity (magnetic field calculation points) are discretely arranged, and the electric field intensity and the magnetic field intensity are alternately calculated along the time axis. In the FDTD method, in the virtual space in which the shape of the physical object is defined, a plurality of rectangular parallelpiped cells is set. Each cell is given an electric constant, for example, a permittivity, a permeability and an electrical conductivity, according to characteristics of a medium (object or air) included in a large amount in the cell. In each cell, an electric field calculation point is arranged at the center of each side, and a magnetic field calculation point is arranged at the center of each face. In the FDTD method, since cells are set in the virtual space, electric field calculation points and magnetic field calculation points are discretely arranged and electric field intensities at the electric field calculation points and magnetic field intensities at the magnetic field calculation points are calculated. In the FDTD method, the simulation is finished in the time domain where each of the electric field intensity and the magnetic field intensity converges to substantially zero.

The FDTD method is a time domain analysis. In the evaluation of measurement defined in an electromagnetic interference (EMI) standard such as VCCI, a frequency is set on the horizontal axis, and an electric field intensity is set on the vertical axis. Accordingly, the analysis result in the time domain in the FDTD method is converted into the frequency domain result. For example, when the time domain is analyzed using a noise source, a limit is set to the frequency of a noise source so that the simulation may be performed for a practical computer occupation time. In the time domain analysis such as the FDTD method, as an observation time becomes longer, the number of calculation steps is increased, and thus, a calculation amount is increased and a computer occupation time also becomes longer. When the observation time is shortened so that the computer occupation time becomes practical, the frequency of a noise source is limited. According to the reduction of the frequency, the prediction accuracy may be lowered.

The computer occupation time may be reduced focusing on the behavior of an electromagnetic wave at each frequency. The behavior of the electromagnetic wave at each frequency, for example, a frequency response, is determined based on an impedance distribution of a system, a housing shape or the like. The system is an electronic device to be simulated or a computation model that imitates the electronic device. When the system is linear, the system may not depend on the intensity of the electromagnetic wave. In the linear system, even when an amplitude of a noise voltage is varied, only an electric field intensity to be observed is changed, but the behavior at each frequency is not changed. For example, in the linear system, even when the amplitude of the noise voltage is varied, a portion on which the electromagnetic wave may be easily concentrated and a portion on which the electromagnetic wave may be hardly concentrated are not changed. The property of the electromagnetic wave is the same for the radiation field.

By using the physical properties described above, the electric field intensity may be accurately obtained by an FDTD method within a practical computer occupation time.

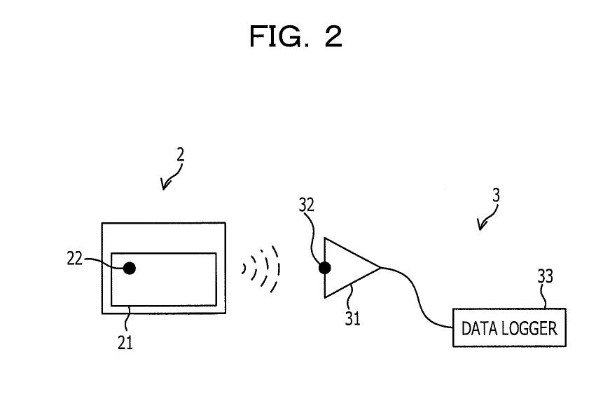

FIG. 2 illustrates an example of a system. In FIG. 2, the configuration of the system which represents an actual environment is illustrated. The system includes an electronic device 2 and an observation device 3. The electronic device 2 includes a substrate 21. The substrate 21 includes a noise source, for example, a first point 22. The observation device 3 includes an antenna 31 and a data logger 33 which records a noise observed at the antenna 31. The antenna 31 includes an observation point 32 at which a noise is observed, for example, a second point. What is represented the actual environment illustrated in FIG. 2 as a computation model may correspond to the system. In a simulation, a noise to be measured at the observation point 32 is obtained by calculation. Accordingly, the model may be created simply by an ideal antenna present at the observation point 32. The antenna 31 and the data logger 33 may not be included in the system.

An electronic device (an object) to be evaluated may be modeled as analysis model data (design data) 141 in the simulation. The analysis model data 141 include data on the shape, the physical property value and the wave source data of the electronic device as an electric field intensity prediction target. The shape data may include a housing shape and a substrate shape, or include only the substrate shape. The physical property value is a value for obtaining an electric constant such as a relative permittivity or a relative permeability, and may be determined according to the material used for a housing or a substrate. The physical property value may be set as a conventionally known value. The analysis model data 141 are stored in the mass storage device 14.

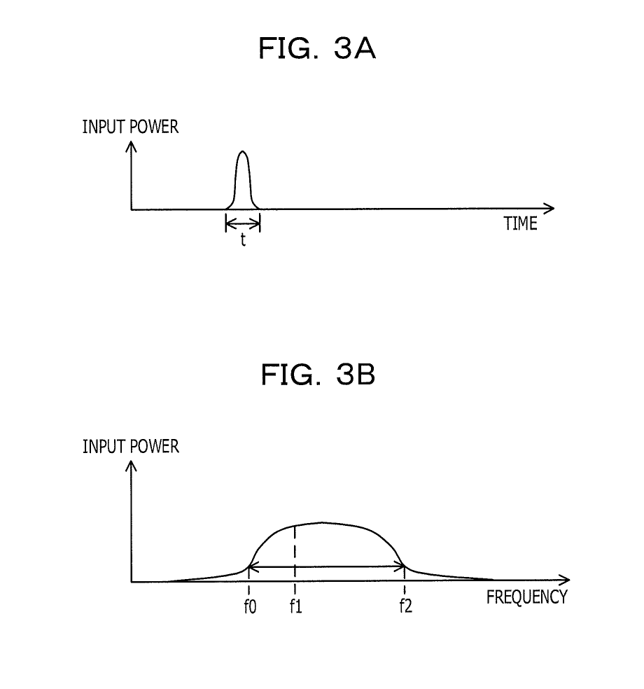

A reference wave is a noise wave as a reference, and may include a sufficient range of frequencies to be investigated. The excitation time may be short. When the excitation time is short, the time for recovery to a steady state may be reduced. Thus, the calculation amount in the FDTD method may be reduced. The reference wave is, for example, a Gaussian pulse, a differential Gaussian pulse, or a pulse modulated at a specific frequency. FIGS. 3A and 3B illustrate an example of a reference wave. FIG. 3A illustrates a waveform when viewed on the time axis, in which the horizontal axis indicates a time, and the vertical axis indicates an input power. FIG. 3B illustrates a waveform when viewed on the frequency axis, in which the horizontal axis indicates a frequency and the vertical axis indicates an input power. A suitable waveform may include a narrow time band as illustrated in FIG. 3A, and a wide frequency band as illustrated in FIG. 3B. For example, a Gaussian pulse may be used.

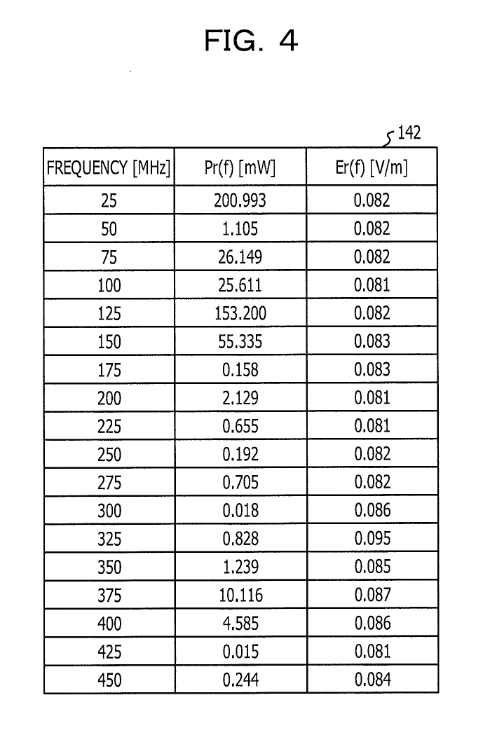

FIG. 4 illustrates an example of a record layout of a reference table. The reference table 142 includes a frequency column, a Pr(f) column, and an Er(f) column. The reference table 142 is a table for recording results is obtained by the simulation and corresponds to variable data, such as an electric field intensity, to be observed at a second point, for example, at the far field, when a reference wave serving as a noise is input to a first point of an analysis model. For example, when the reference wave is input to the first point of the electronic device, a variation of a reference signal at the second point is obtained through simulation, and the obtained variation of the reference signal is converted into variable data at each frequency and recorded in the reference table. For example, the variation of the reference signal at the second point may be represented as the electric field intensity in the time domain obtained by the FDTD method. In the frequency column, frequency values in a certain range are recorded. For example, in FIG. 4, a unit is MHz, and frequencies ranging from 25 MHz to 450 MHz are recorded at a pitch of 25 MHz. In the Pr(f) column, a power of a reference wave at each frequency is recorded. For example, a unit is mW in FIG. 4. In the Er(f) column, values of electric field intensities observed at a predetermined far field are recorded. For example, a unit is V/m in FIG. 4. The far field may be located 10 m from the object device (analysis model) at, for example, a MHz band, or 3 m from the object device at a GHz band.

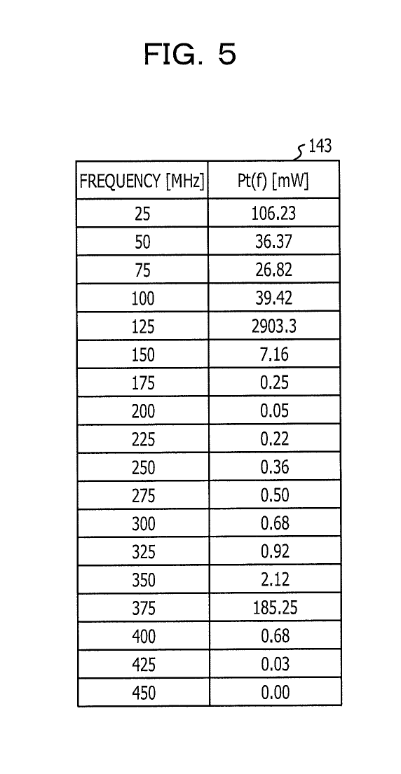

FIG. 5 illustrates an example of a record layout of a test table. In the test table 143, data on a noise wave to be tested are recorded. The test table 143 includes a frequency column, and a Pt(f) column. In the frequency column, the same values as those set in the frequency column of the reference table 142 are recorded. In the Pt(f) column, a power of a noise wave at each frequency is recorded, and its unit is mW. A signal applied to the first point is decomposed by frequencies, and a signal (power) at each frequency is recorded in the test table 143. In the frequency decomposition, for example, Fourier transform may be used.

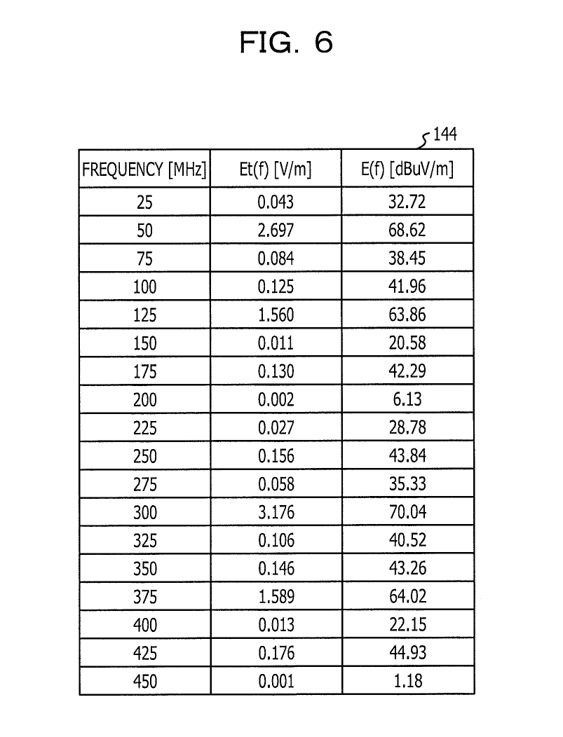

FIG. 6 illustrates an example of a record layout of an electric field intensity table. In the electric field intensity table 144, a prediction result is recorded. The electric field intensity table 144 includes a frequency column, an Et(f) column, and an E(f) column. In the frequency column, the same values as those set in the frequency column of the reference table 142 are recorded. In the Et(f) column, an electric field intensity at the far field is recorded and its unit is V/m. In the E(f) column, an electric field intensity finally obtained at the far field is recorded and its unit is dBuV/m. In the electric field intensity table 144, a frequency distribution of the signal at the second point is recorded.

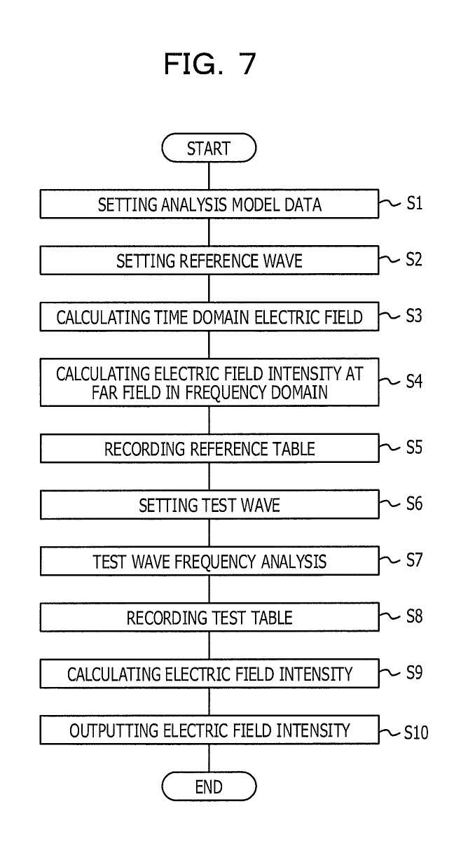

In the electric field intensity predicting apparatus 1, when the electric field intensity predicting program 1P is executed, an electric field intensity prediction processing is performed. FIG. 7 illustrates an example of an electric field intensity prediction processing. The CPU 11 of the electric field intensity predicting apparatus 1 sets the analysis model data 141 (operation S1).

The CPU 11 sets a reference wave (operation S2). As for the reference wave, a Gaussian pulse may be used. Waveform data of the reference wave may include a group of data including, for example, a plurality of sets of elapsed time from the initiation of simulation and input power. The waveform data of the reference wave may be expressed by a function of time. The relationship of a frequency and a power value, which is obtained through Fourier transform of the waveform data of the reference wave, is recorded in the frequency column, and the Pr(f) column of the reference table 142.

The CPU 11 performs a time domain electric field calculation (operation S3). An FDTD method may be used. When the reference wave is applied to a certain position of the analysis model, an electric field and a magnetic field within the analysis region are obtained in the time domain.

The CPU 11 uses the obtained electric and magnetic fields within the analysis region of the time domain to calculate the electric field intensity of the far field in the frequency domain at the observation point (operation S4).

The far field electric field intensity outside the analysis region may be relatively easily calculated by calculating radiation from a secondary wave source when an equivalent electromagnetic flow converted from electric and magnetic fields that pass through a closed space surrounding the radiation source within the analysis region is set as the secondary wave source. The far field calculation may be performed by performing a Fourier transform on an equivalent electromagnetic flow in the time domain, and a phase shift to an observation point. The far field in the time domain may be calculated and subjected to a Fourier transform, and then the far field electric field intensity calculation may be performed in the frequency domain. There is no limitation in the method for calculating the far field electric field intensity in the frequency domain. The results are recorded in the reference table 142 (operation S5).

The CPU 11 sets a test wave (operation S6). The test wave may be a noise wave to be analyzed. As the test wave, an actually measured noise wave may be used, or a noise wave which is assumed to be generated by an analysis tool may be used. An analysis of the noise wave generation may not be a three-dimensional electromagnetic field analysis, but may be performed using, for example, a simulation program with integrated circuit emphasis (SPICE). The data of the test wave, like data of the reference wave, may include a group of data including, for example, a plurality of sets of the elapsed time and the input power. The data may be expressed by a function with respect to time as an argument. The data of the test wave are recorded in the RAM 12 or the mass storage device 14.

The CPU 11 performs a frequency analysis of the test wave (operation S7). The test wave is subjected to a Fourier transform, and is converted from data in the time domain into data in the frequency domain. The relationship between the frequency and the power, obtained through the conversion, is recorded in the test table 143 (operation S8). The example of the test table 143 is illustrated in FIG. 5.

The CPU 11 uses the values in the reference table 142 and the test table 143 to calculate the electric field intensity in the far field when the test wave is input (operation S9). The CPU 11 outputs the calculated result (operation S10). The output result may be displayed on a display unit coupled to the electric field intensity predicting apparatus 1 or recorded in the electric field intensity table 144. Both the display and recording may be performed. The CPU 11 finishes the processing. The example of the output electric field intensity table 144 is illustrated in FIG. 6.

The calculation of the electric field intensity may be performed as described below. The power of the system may satisfy following Equation 1.

[Total Power]=[Power generated by noise source]=[radiation power+power consumed at substrate loss] (1)

The behavior of an electromagnetic wave is not changed even if power is changed. Accordingly, even when the magnitude of the total power is changed, the ratio of [radiation power] to [power consumed at substrate loss] may not be changed. The ratio of Pr(f) to Er(f) (the power to electric field intensity of the reference wave) recorded in the reference table 142 is the same as the ratio of Pt(f) to Et(f) (the power to electric field intensity of the test wave), and thus following Equation (2) may be satisfied.

Et(f)=Er(f)×Pt(f)/Pr(f) (2)

The obtained electric field intensity Et(f) may be substituted into Equation (3) and the unit may be converted into [dBuv/m] to obtain a final value, E(f).

E(f)=20×log(Et(f)) (3)

For example, at 25 MHz, Pr(f) is 200.993 mW, and Er(f) is 0.082 V/m. Pt(f) is 106.23.

Accordingly, Et(f)=0.082×106.23/200.993=0.043. In FIGS. 4 to 6, the values are represented to two or three decimal places. However, the calculation of Et(f) is performed to more decimal places. Accordingly, there may be a slight difference between the value of Et(f) calculated by numerical values illustrated in FIGS. 4 and 5, and the value of Et(f) illustrated in FIG. 6.

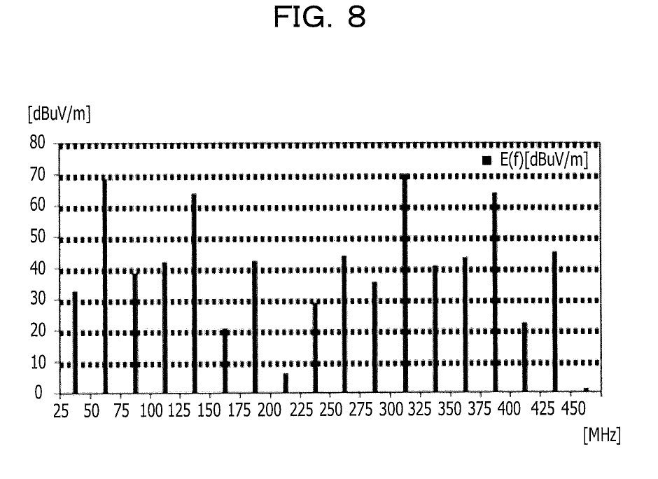

FIG. 8 illustrates an example of the obtained electric field intensity. The horizontal axis indicates a frequency with a unit of MHz, and the vertical axis indicates an electric field intensity with a unit of dBuV/m. When the graph illustrated in FIG. 8 is displayed on the display unit, the state of the electric field intensity at each frequency may be easily recognized.

The electromagnetic field calculation in the time domain is performed on only a reference wave with a narrow time band, and the input power and the electric field intensity value are obtained at each frequency. By using the result, an electric field intensity value on the test wave is calculated. Therefore, it may be possible to accurately obtain a prediction result within a practical computer occupation time.

FIG. 7 illustrates a series of processings from setting of the analysis model data 141 (operation S1) to output of an electric field intensity (operation S10). A part of processings to be repeatedly performed may be omitted. When the shape data of the analysis model are not largely changed, the result of the electromagnetic field calculation on the reference wave is hardly changed. Accordingly, in such a case, processings from operation S1 to operation S5 in FIG. 7 may be omitted. Processings subsequent to operation S6 may be performed using the reference table 142 which has been created in advance. The case in which the shape data are not largely changed may include a case in which a value of a damping resistor mounted on a line having a noise source is changed.

When minor changes occur in a design, the reference table 142 is not created again. Thus, a time to obtain the solution may be reduced.

When a plurality of noise sources is present, the calculation as described above may be performed for each of the noise sources. After calculations on all the noise sources are finished, electric field intensity values obtained from the calculation results may be added up for each frequency so that a prediction result in a case of the plurality of noise sources may be obtained. Other matters may have the same as or similar to configuration as described above, and descriptions thereof may be omitted.

Even when a plurality of noise sources is present, the electromagnetic field calculation in the time domain that requires a large calculation amount is performed only on the reference wave with a narrow time band rather than the test wave. Accordingly, an increase of a computer occupation time is reduced so that the electric field intensity in the far field may be accurately obtained.

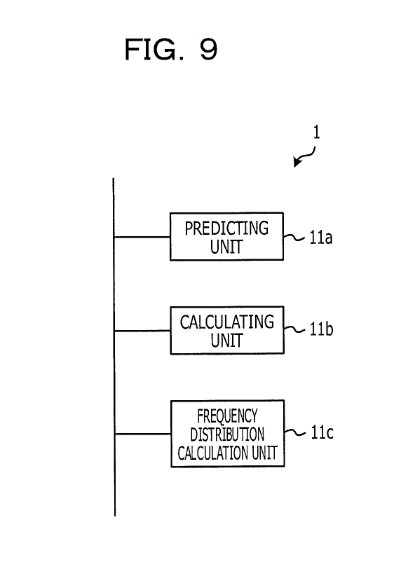

FIG. 9 illustrates an example of an electric field intensity predicting apparatus. In FIG. 9, the functional configuration of the electric field intensity predicting apparatus 1 is illustrated. The electric field intensity predicting apparatus 1 includes a predicting unit 11a, a calculating unit 11b, and a frequency distribution calculating unit 11c. When the CPU 11 executes, for example, the electric field intensity predicting program 1P, the electric field intensity predicting apparatus 1 is operated as described below.

When a reference signal including a plurality of frequencies is input to a first point of design data of an object, the predicting unit 11a obtains a variation of the reference signal at a second point by electromagnetic field simulation. The calculating unit 11b calculates variable data at each of the plurality of frequencies based on the obtained variation of the reference signal. The frequency distribution calculating unit 11c decomposes the signal applied to the first point by frequencies, and calculates a frequency distribution of the signal propagated from the first point to the second point, based on the frequency-decomposed signal and the variable data at each frequency.

As the time domain analysis method, an FDTD may be used. Alternatively, for example, a transmission line matrix (TLM) method, or a finite integration technique (FIT) may be used as well.

The above described technical features (configuration requirements) may be combined with each other so that new technical features may be formed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. An electromagnetic field simulation method comprising:
Obtaining, when a reference signal including a plurality of frequencies is input to a first point of design data of an object, a variation of a reference signal at a second point by a computer through an electromagnetic field simulation;
calculating variable data at each of the plurality of frequencies based on the variation of the reference signal;
frequency-decomposing a signal applied to the first point; and
calculating a frequency distribution of the signal at the second point which propagats from the first point based on the frequency-decomposed signal and the variable data at each of the plurality of frequencies.

2. The electromagnetic field simulation method according to claim 1, wherein an electric field intensity is calculated as the variable data at each of the plurality of frequencies.

3. The electromagnetic field simulation method according to claim 2, wherein the variable data at each of the plurality of frequencies includes the electric field intensity and a first power which are associated with each of the plurality of frequencies.

4. The electromagnetic field simulation method according to claim 3, wherein a second power is associated with at each of the plurality of frequencies in the frequency-decomposed signal.

5. The electromagnetic field simulation method according to claim 4, wherein the frequency distribution of the signal at the second point is calculated based on a ratio of the first power to the second power and the electric field intensity.

6. The electromagnetic field simulation method according to claim 1, wherein a Gaussian pulse is used as the reference signal.

7. An electromagnetic field simulation method, comprising:
obtaining, when a reference signal including a plurality of frequencies is input to each of a plurality of third points of design data of an object, a variation of the reference signal at the second point through an electromagnetic field simulation, the plurality of third points being included in a first point of the design data of an object:
calculating variable data at each of the plurality of frequencies based on the variation of the reference signal;
frequency-decomposing a signal applied to each of the third points;
calculating a frequency distribution of the signal propagated at second point which propagates from each of the third points based on the frequency-decomposed signal and the variable data at each of the plurality of frequencies; and
synthesizing a plurality of frequency distributions on the plurality of third points.

8. The electromagnetic field simulation method according to claim 7, wherein an electric field intensity is calculated as the variable data at each of the plurality of frequencies.

9. The electromagnetic field simulation method according to claim 8, wherein the variable data at each of the plurality of frequencies includes the electric field intensity and a first power which are associated with each of the plurality of frequencies.

10. The electromagnetic field simulation method according to claim 9, wherein a second power is associated with at each of the plurality of frequencies in the frequency-decomposed signal.

11. The electromagnetic field simulation method according to claim 10, wherein the frequency distribution of the signal at the second point is calculated based on a ratio of the first power to the second power and the electric field intensity.

12. The electromagnetic field simulation method according to claim 7, wherein a Gaussian pulse is used as the reference signal.

13. An electromagnetic field simulation system comprising:
a processor; and
a memory configured to store an electromagnetic field simulation program to be executed by the processor,
wherein the processor, based on the electromagnetic field simulation program, performs operations to:
obtain, when a reference signal including a plurality of frequencies is input to a first point of design data of an object, a variation of a reference signal at a second point through an electromagnetic field simulation;
calculate variable data at each of the plurality of frequencies based on the variation of the reference signal;
frequency-decompose a signal applied to the first point; and
calculate a frequency distribution of the signal at the second point which propagates from the first point based on the frequency-decomposed signal and the variable data at each of the plurality of frequencies.

14. The electromagnetic field simulation system according to claim 13, further comprising a storage device configured to store the variable data.

15. The electromagnetic field simulation system according to claim 13, wherein an electric field intensity is calculated as the variable data at each of the plurality of frequencies.

16. The electromagnetic field simulation system according to claim 15, wherein the variable data at each of the plurality of frequencies includes the electric field intensity and a first power which are associated with each of the plurality of frequencies.

17. The electromagnetic field simulation system according to claim 16, wherein a second power is associated with at each of the plurality of frequencies in the frequency-decomposed signal.

18. The electromagnetic field simulation system according to claim 17, wherein the frequency distribution of the signal at the second point is calculated based on a ratio of the first power to the second power and the electric field intensity.

19. The electromagnetic field simulation system according to claim 13, wherein a Gaussian pulse is used as the reference signal.
